(19) United States
(12) Patent Application Publication
(10) Pub. No.: US 2019/0001422 A1
(43) Pub. Date: Jan. 3, 2019

(54) DRILL BIT

(71) Applicant: SHEHKAI PRECISION CO., LTD., Kaohsiung City (TW)

(72) Inventors: Wen-Kuan WANG, Hsinchu City (TW); Jiann-Jong SU, Miaoli County (TW); Tai-Chun YEH, Miaoli County (TW); Jen-Yu WENG, Miaoli County (TW); Kuan-Yi YU, Hsinchu City (TW)

(21) Appl. No.: 15/639,922

(22) Filed: Jun. 30, 2017

(51) Int. Cl. B23B 51/02

(52) U.S. Cl. CPC B23B 51/02; B23B 2251/14; B23B 2251/408; B23B 2251/202; B23B 2251/204; B23B 2251/18

(57) ABSTRACT

A drill bit includes a cutting head and a bit body. The cutting head has a tip and cutting parts. The bit body is connected to the cutting head and has a longitudinal axis extending through the tip. The bit body has chip discharge flutes. The cutting parts are disposed at different angular positions around the longitudinal axis. Each cutting part is concaved inwardly and bounds one of the chip discharge flutes. Each of the cutting parts includes a rake face that has a corner edge adjacent to a respective one of the chip discharge flutes. When a bottom of the cutting head is viewed in a direction parallel to the longitudinal axis of the bit body, the corner edge has an obtuse included angle.

### FIELD

The disclosure relates to a drill bit, and more particularly to a drill bit that has a rake face formed with an obtuse corner for cutting operation.

### BACKGROUND

Referring to FIG. 1, a drill bit, disclosed in Taiwanese Patent Application Publication No. I231255, includes a bit body (not shown) and a cutting head 13 that is made of a super hard alloy and that is fixedly attached to the bit body by brazing, welding, or the like. The cutting head 13 includes first, second and third cutting parts 13a, 13b, 13c. The first, second and third cutting parts 13a, 13b, 13c define therebetween three concavities 15 that are continuations of three chip discharge flutes (not shown) of the bit body. Each of the cutting parts 13a, 13b, 13c has a rake face 16 with a corner edge 161. When a bottom of the cutting head 13 is viewed in a direction parallel to a longitudinal axis of the bit body (not shown), the corner edge 161 has an angle of substantially 90 degrees, which may result in unsmooth cutting operation and even destruction to the drill bit.

### SUMMARY

Therefore, an object of the disclosure is to provide a drill bit that can provide relatively smooth cutting operation and is relatively durable.

According to the disclosure, a drill bit includes a cutting head and a bit body.

The cutting head has a tip and a plurality of cutting parts.

The bit body is connected to the cutting head and has a longitudinal axis extending through the tip. The bit body has a plurality of chip discharge flutes that extend from the bit body to the cutting head and that are angularly spaced from each other around the longitudinal axis of the bit body. The cutting parts are disposed at different angular positions around the longitudinal axis. Each of the cutting parts is concaved inwardly and bounds one of the chip discharge flutes. Each of the cutting parts includes a rake face 311 that has a corner edge adjacent to a respective one of the chip discharge flutes.

When a bottom of the cutting head is viewed in a direction parallel to the longitudinal axis of the bit body, the corner edge has an obtuse included angle.

### BRIEF DESCRIPTION OF THE DRAWINGS

Other features and advantages of the disclosure will become apparent in the following detailed description of the embodiments with reference to the accompanying drawings, of which:

FIG. 1 illustrates a drill bit of Taiwanese Patent Application Publication No. I231255;

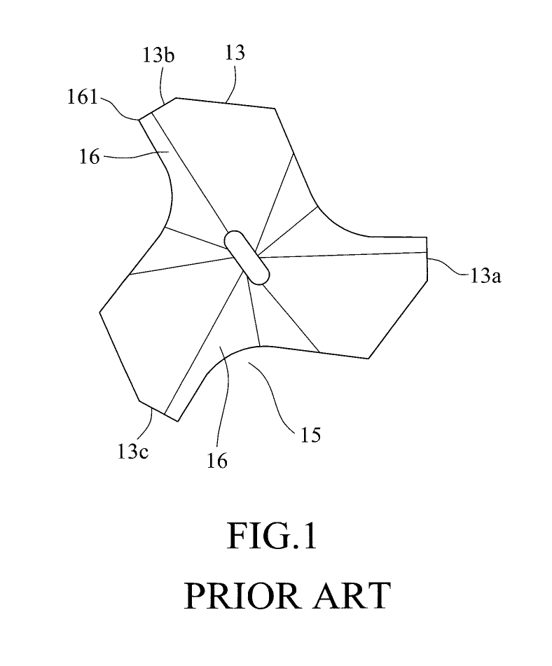

FIG. 2 illustrates a drill bit according to a first embodiment of the present disclosure;

FIG. 3 is a bottom view of the first embodiment;

FIG. 4 is a bottom view of the second embodiment of the present disclosure;

FIG. 5 is a perspective view, illustrating the third embodiment; and

FIG. 6 is a bottom view of the third embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

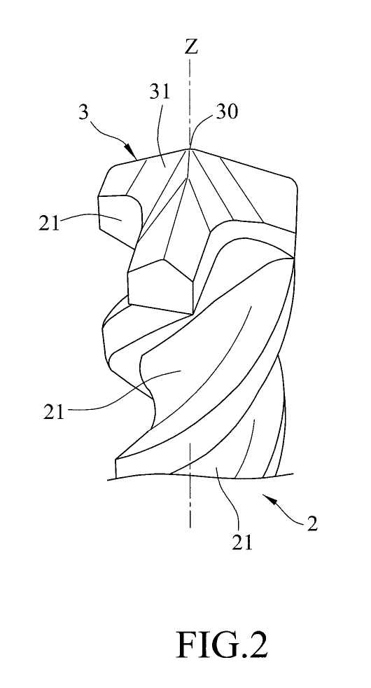

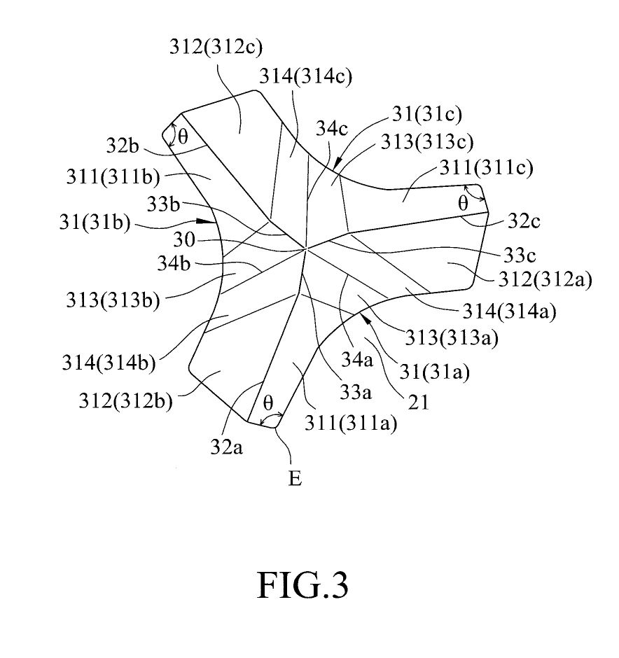

Referring to FIGS. 2 to 3, a drill bit according to an embodiment of the present disclosure includes a bit body 2 and a cutting head 3. The cutting head 3 has a tip 30 and a plurality of cutting parts 31. The bit body 2 is connected to the cutting head 3 and has a longitudinal axis (Z) extending through the bit body 2 and the tip 30. The bit body 2 has a plurality of chip discharge flutes 21 that extend from the bit body 2 to the cutting head 3 and that are angularly spaced from each other around the longitudinal axis (Z) of the bit body 2. The cutting parts 31 are disposed at different angular positions around the longitudinal axis (Z).

Each cutting part 31 is concaved inwardly and bounds one of the chip discharge flutes 21. Each cutting part 31 includes a rake face 311, a flank 312, a first connection face 313 and a second connection face 314. The rake face 311 has a corner edge (E) adjacent to a respective one of the chip discharge flutes 21. The flank 312 is spaced apart from the rake face 311. The first connection face 313 is disposed between the flank 312 and the rake face 311 and adjoins the rake face 311. The second connection face 314 is connected between the first connection face 313 and the flank 312.

As shown in FIG. 3, when a bottom of the cutting head 3 is viewed in a direction parallel to the longitudinal axis (Z) of the bit body 2, the corner edge (E) has an obtuse included angle (θ). When the cutting head 3 counterclockwise rotates and cuts into a concrete structure (not shown), the obtuse included angle (θ) enables the cutting head 3 to operate smoothly, and the cutting head 3 is not easily damaged. In this embodiment, the obtuse included angle (θ) is greater than 90 degrees, but smaller than 120 degrees.

Referring back to FIGS. 2 and 3, the bit body 2 has three chip discharge flutes 21, and the cutting head 3 has three cutting parts 31. Specifically, for each cutting part 31, the first and second connection faces 313, 314 are concaved relative to the rake face 311 and the flank 312. The first connection faces 313 and the second connection faces 314 of the three cutting parts 31 intersect at the tip 30 of the cutting head 3.

In more details, as shown in FIG. 3, the three cutting parts 31 are disposed consecutively along a rotation direction of the bit body 2 and include first, second and third cutting parts 31a, 31b, 31c. Therefore, the first cutting part 31a includes the rake face 311a, the flank 312a, the first connection face 313a and the second connection face 314a. The second cutting part 31b includes the rake face 311b, the flank 312b, the first connection face 313b and the second connection face 314b. The third cutting part 31c includes the rake face 311c, the flank 312c, the first connection face 313c and the second connection face 314c.

The rake face 311a of the first cutting part 31a borders the flank 312b of the second cutting part 31b along a cutting edge 32a. The first connection face 313a of the first cutting part 31a borders the second connection face 314b of the second cutting part 31b along a middle boundary line 33a. The first connection face 313c of the third cutting part 31c borders the second connection 314c of the third cutting part 31c along an indented boundary line 34c. When the bottom of the cutting head 3 is viewed in the direction parallel to the longitudinal axis (Z) of the bit body 2, the cutting edge 32a and the middle boundary line 33a do not lie on a same straight line, the middle boundary line 33a and the indented boundary line 34c do not lie on a same straight line, and the cutting edge 32a and the indented boundary line 34c do not lie on a same straight line.

The rake face 311b of the second cutting part 31b borders the flank 312c of the third cutting part 31c along a cutting edge 32b. The first connection face 313b of the second cutting part 31b borders the second connection face 314c of the third cutting part 31c along a middle boundary line 33b. The first connection face 313a of the first cutting part 31a borders the second connection face 314a of the first cutting part 31a along an indented boundary line 34a. When the bottom of the cutting head 3 is viewed in the direction parallel to the longitudinal axis (Z) of the bit body 2, the cutting edge 32d and the middle boundary line 33b do not lie on a same straight line, the middle boundary line 33b and the indented boundary line 34a do not lie on a same straight line, and the cutting edge 32b and the indented boundary line 34a do not lie on a same straight line.

The rake face 311c of the third cutting part 31c borders the flank 312a of the first cutting part 31a along a cutting edge 32c. The first connection face 313c of the third cutting part 31c borders the second connection face 314a of the first cutting part 31a along a middle boundary line 33c. The first connection face 313b of the second cutting part 31b borders the second connection face 314b of the second cutting part 31b along an indented boundary line 34b. When the bottom of the cutting head 3 is viewed in the direction parallel to the longitudinal axis (Z) of the bit body 2, the cutting edge 32c and the middle boundary line 33c do not lie on a same straight line, the middle boundary line 33c and the indented boundary line 34b do not lie on a same straight line, and the cutting edge 32c and the indented boundary line 34b do not lie on a same straight line.

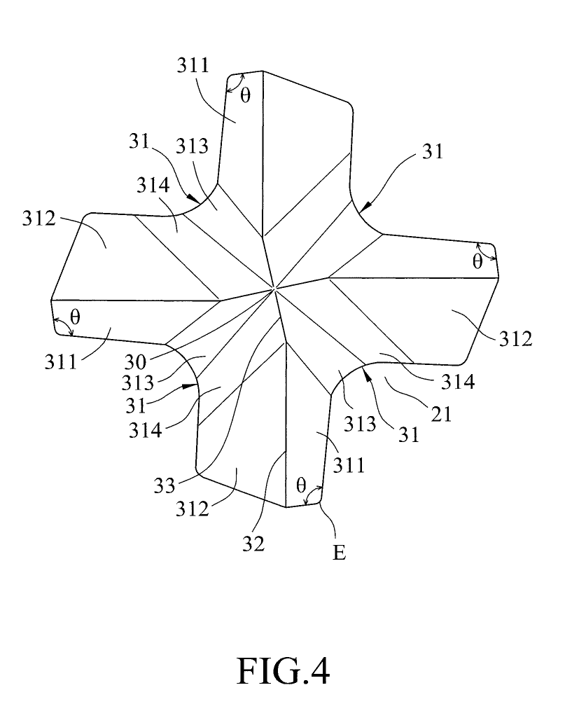

Referring to FIG. 4, in a second embodiment of the drill bit, the cutting head 3 has four cutting parts 31, and the bit body 2 has four chip discharge flutes 21. All of the four first connection faces 313 and the four second connection faces 314 of the four cutting parts 31 intersect at the tip 30 of the cutting head 3. The rake face 311 of one of the cutting parts 31 borders the flank 312 of an adjacent one of the cutting parts 31 along the cutting edge 32. The first connection face 313 of one of the cutting parts 31 borders the second connection face 314 of an adjacent one of the cutting parts 31 along the middle boundary line 33. When the bottom of the cutting head 3 is viewed in the direction parallel to the longitudinal axis (Z) of the bit body 2, the cutting edge 32 between the rake face 311 of each of the cutting parts 31 and the flank 312 of the adjacent one of the cutting parts 31 does not lie on the same straight line with the middle boundary line 33 between the first connection faces 313 of each of the cutting parts 31 and the second connection face 314 of the adjacent one of the cutting parts 31.

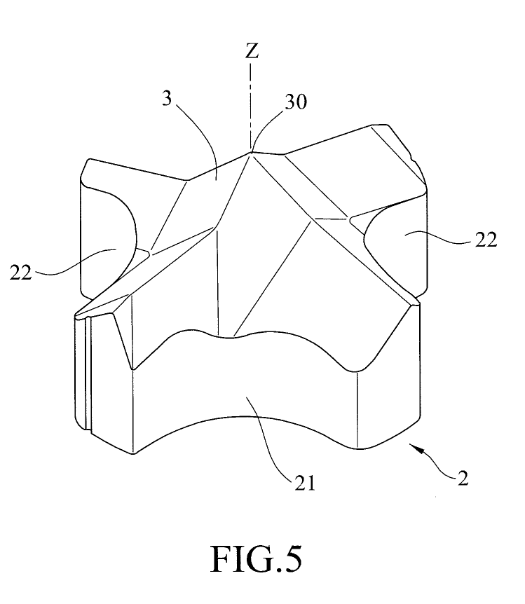

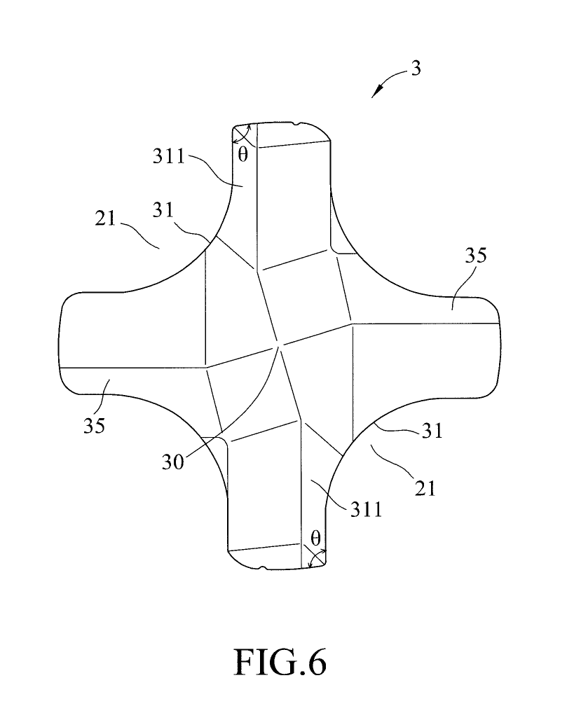

Referring to FIGS. 5 and 6, in a third embodiment of the drill bit, the bit body 2 has two chip discharge flutes 21 and two chip guiding flutes 22. The cutting head 3 has two cutting parts 31 and two chip guiding parts 35. The chip guiding flutes 22 are angularly spaced apart from each other around the longitudinal axis (Z). Each of the chip guiding flutes 22 is disposed between the chip discharge flutes 21. Each of the chip guiding parts 35 is disposed between the cutting parts 31 and bounds one of the chip discharge flutes 21. The cutting parts 31 and the chip guiding parts 35 are disposed alternately, and form a cross shape so that the drill bit is able to rotate balancedly at high speed.

To sum up, because the obtuse included angle (θ) is greater than 90 degrees, but smaller than 120 degrees, the drill bit of the present disclosure can provide relatively smooth cutting operation and is relatively durable in comparison with the drill bit of Taiwanese Patent Application Publication No. I231255.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

1. A drill bit, comprising:
a cutting head having a tip and a plurality of cutting parts;
a bit body connected to said cutting head and having a longitudinal axis extending through said bit body and said tip, said bit body having a plurality of chip discharge flutes that extend from said bit body to said cutting head and that are angularly spaced from each other around said longitudinal axis of said bit body;
said cutting parts being disposed at different angular positions around said longitudinal axis, each of said cutting parts being concaved inwardly and bounding one of said chip discharge flutes, each of said cutting parts including a rake face that has a corner edge adjacent to a respective one of said chip discharge flutes;
wherein said cutting parts includes first, second and third cutting parts that are disposed consecutively along a rotation direction of said bit body, said rake face of said first cutting part bordering said flank of said second cutting part along a cutting edge, said first connection face of said first cutting part bordering said second connection face of said second cutting part along a middle boundary line, said first connection face of said third cutting part bordering said second connection of said third cutting part along an indented boundary line;
wherein, when the bottom of said cutting head is viewed in the direction parallel to said longitudinal axis of said bit body, said cutting edge and said middle boundary line do not lie on a same straight line, said middle boundary line and said indented boundary line do not lie on a same straight line, and said cutting edge and said indented boundary line do not lie on a same straight line; and
wherein said tip is a single point tip, said middle boundary line is straight and has one end meeting said indented boundary line at said tip, another end of said middle boundary line meets said cutting edge such that said cutting edge is spaced from said tip.

2. (canceled)

3. (canceled)

4. (canceled)

5. (canceled)

6. (canceled)

7. (canceled)

8. A drill bit, comprising:
a cutting head having a tip and a plurality of cutting parts; and
a bit body connected to said cutting head and having a longitudinal axis extending through said bit body and said tip, said bit body having a plurality of chip discharge flutes that extend from said bit body to said cutting head and that are angularly spaced from each other around said longitudinal axis of said bit body;
said cutting parts being disposed at different angular positions around said longitudinal axis, each of said cutting parts being concaved inwardly and bounding one of said chip discharge flutes, each of said cutting parts including a rake face that has a corner edge adjacent to a respective one of said chip discharge flutes;
wherein said bit body has four chip discharge flutes, said cutting head having four cutting parts;
wherein each of said cutting parts further includes a flank spaced apart from said rake face, a first connection face disposed between said flank and said rake face and adjoining said rake face, and a second connection face connected between said first connection face and said flank, said first and second connection faces being concaved relative to said rake face and said flank, all of said first connection faces and said second connection faces of said four cutting parts intersecting at said tip of said cutting head;
wherein said rake face of each of said cutting parts bordering said flank of an adjacent one of said cutting parts along a cutting edge, said first connection face of each of said cutting parts bordering said second connection face of an adjacent one of said cutting parts along a middle boundary line;
wherein, when the bottom of said cutting head is viewed in the direction parallel to said longitudinal axis of said bit body, said cutting edge between said rake face of each of said cutting parts and said flank of the adjacent one of said cutting parts does not lie on the same straight line with said middle boundary line between said first connection faces of each of said cutting parts and the adjacent one of said second connection faces of said cutting parts; and
wherein said tip is a single point tip, said middle boundary line is straight, and has one end meeting said tip, another end of said middle boundary line meets said cutting edge such that said cutting edge is spaced from said tip.

9. A drill bit, comprising:
a cutting head having a tip and two cutting parts;
a bit body connected to said cutting head and having a longitudinal axis extending through said bit body and said tip, said bit body having two chip discharge flutes that extend from said bit body to said cutting head and that are angularly spaced from each other around said longitudinal axis of said bit body;
said cutting parts being disposed at different angular positions around said longitudinal axis, each of said cutting parts being concaved inwardly and bounding one of said chip discharge flutes, each of said cutting parts including a rake face that has a corner edge adjacent to a respective one of said chip discharge flutes;
wherein said bit body further has two chip guiding flutes, said chip guiding flutes being angularly spaced apart from each other around said longitudinal axis, each of said chip guiding flutes being disposed between said chip discharge flutes; and
wherein said cutting head further has two chip guiding parts, each of said chip guiding parts being disposed between said cutting parts and bounding one of said chip discharge flutes.

10. The drill bit as claimed in claim 1, wherein, when a bottom of said cutting head is viewed in a direction parallel to said longitudinal axis of said bit body, said corner edge has an obtuse included angle.

11. The drill bit as claimed in claim 10, wherein said obtuse included angle is greater than 90 degrees, but smaller than 120 degrees.
